(19) United States
(12) Patent Application Publication
(10) Pub. No.: US 2011/0038356 A1
(43) Pub. Date: Feb. 17, 2011

(54) VBR interference mitigation in an mmwave network

(76) Inventor: Yuval Bachrach, Haife (IL)

Correspondence Address: SCHUBERT LAW GROUP PLLC;c/o CPA Global, P.O. BOX 52050, MINNEAPOLIS, MN, 55402, US

(21) Appl. No.: 12/583,060

(22) Filed: Aug. 13, 2009

(51) Int. Cl. H04B 7/212; H04J 3/00

(52) U.S. Cl. 370/337; 370/336

(57) ABSTRACT

Methods, apparatuses, and systems to generate accurate interference signatures are disclosed. An apparatus embodiment may be a transmitting device that transmits VBR data. The transmitting device may be allotted a number of sub-slots in which the transmitting device uses to transmit the VBR data. However, the communicating device may rarely use all of the allotted slots and routinely use only a few of the sub-slots. A receiving device that may be affected by transmissions from the transmitting device, such as a receiver in a neighboring network, may monitor the channel to develop an interference pattern or interference signature. To enable the receiving device to develop an accurate interference signature, the transmitting device may transmit data over each of the allotted sub-slots within a predetermined period.

### FIELD

The present disclosure relates generally to the field of communications. More particularly, the present disclosure relates to generating interference signatures by variable bit rate (VBR) transmitting devices in a millimeter wave (mmWave) network to mitigate interference.

### BRIEF DESCRIPTION OF THE DRAWINGS

Aspects of the embodiments will become apparent upon reading the following detailed description and upon reference to the accompanying drawings in which like references may indicate similar elements:

FIG. 1 illustrates a data transmission scheme in which information may be transmitted through wireless network;

FIG. 2 illustrates how an embodiment may employ an interference mitigation scheme in a millimeter wave (mmWave) network;

FIG. 3 illustrates how a transmitter may transmit data for a sub-slot allocation;

FIG. 4 depicts an embodiment of a network coordinator;

FIG. 5 depicts an apparatus that may transmit VBR data to enable generation of more accurate interference signatures; and

FIG. 6 illustrates a process of transmitting VBR data to develop an accurate interference signature in an mmWave network.

### DETAILED DESCRIPTION OF EMBODIMENTS

The following is a detailed description of novel embodiments depicted in the accompanying drawings. However, the amount of detail offered is not intended to limit anticipated variations of the described embodiments; on the contrary, the claims and detailed description are to cover all modifications, equivalents, and alternatives falling within the spirit and scope of the present teachings as defined by the appended claims. The detailed descriptions below are designed to make such embodiments understandable to a person having ordinary skill in the art.

Generally speaking, methods, apparatuses, and systems to generate accurate interference signatures are contemplated. An apparatus embodiment may be a laptop or networking device with wireless communications capabilities. The communicating device may be a transmitting device that associates or connects with another device in an mmWave network. Additionally, the communicating device may be a network coordinator that communicates with other devices in the mmWave network, scheduling transmissions of the other devices. In different networks, different acronyms can be used for specifying the coordinator or coordination functionality. One example is Access Point at TGad (802.11ad Task Group). The communicating device may be allotted a number of sub-slots in which the communicating device uses to transmit VBR data. However, the communicating device may rarely use all of the allotted slots and routinely use only a few of the sub-slots. A receiving device that may be affected by transmissions from the communicating device, such as a receiver in a neighboring network, may monitor the channel to develop an interference pattern or interference signature. To enable the receiving device to develop an accurate interference signature, the communicating device may transmit data over each of the allotted sub-slots within a predetermined period.

Various embodiments disclosed herein may be used in a variety of applications. Some embodiments may be used in conjunction with various devices and systems, for example, a transmitter, a receiver, a transceiver, a transmitter-receiver, a wireless communication station, a wireless communication device, a wireless Access Point (AP), a modem, a wireless modem, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, a network, a wireless network, a Local Area Network (LAN), a Wireless LAN (WLAN), a Metropolitan Area Network (MAN), a Wireless MAN (WMAN), a Wide Area Network (WAN), a Wireless WAN (WWAN), devices and/or networks operating in accordance with existing IEEE 802.16e, 802.20, 3 GPP Long Term Evolution (LTE) etc. and/or future versions and/or derivatives and/or Long Term Evolution (LTE) of the above standards, a Personal Area Network (PAN), a Wireless PAN (WPAN), units and/or devices which are part of the above WLAN and/or PAN and/or WPAN networks, one way and/or two-way radio communication systems, cellular radio-telephone communication systems, a cellular telephone, a wireless telephone, a Personal Communication Systems (PCS) device, a PDA device which incorporates a wireless communication device, a Multiple Input Multiple Output (MIMO) transceiver or device, a Single Input Multiple Output (SIMO) transceiver or device, a Multiple Input Single Output (MISO) transceiver or device, a Multi Receiver Chain (MRC) transceiver or device, a transceiver or device having “smart antenna” technology or multiple antenna technology, or the like.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), Orthogonal Frequency-Division Multiple Access (OFDMA), Time-Division Multiplexing (TDM), Time-Division Multiple Access (TDMA), Extended TDMA (E-TDMA), Code-Division Multiple Access (CDMA), Multi-Carrier Modulation (MDM), Discrete Multi-Tone (DMT), Bluetooth(™), ZigBee(™), or the like. Embodiments may be used in various other apparatuses, devices, systems and/or networks.

While some of the specific embodiments described below will reference the embodiments with specific configurations, those of skill in the art will realize that embodiments of the present disclosure may advantageously be implemented with other configurations with similar issues or problems.

WPAN communication systems are extensively used for data exchange between devices over relatively short distances, usually no more than 10 meters. Current WPAN systems may exploit the frequency band in the 2-7 gigahertz (GHz) frequency band region and achieve throughputs of up to several hundred Mbps (for Ultra-WideBand systems).

The availability of the 7 GHz of unlicensed spectrum in the 60 GHz band and the progress in the radio frequency integrated circuit (IC) semiconductor technologies are pushing the development of the millimeter-Wave (mmWave) WPAN systems which operate in the 60 GHz band and achieving throughputs of several gigabits-per-second (Gbps). A number of standardization groups, such as the Institute of Electrical and Electronics Engineers (IEEE) 802.15.3c, Wireless HD Special Interest Group (SIG), and ECMA TG20, have developed specifications for such mmWave WPAN networks.

A mmWave communication link may impose more system limitations, in terms of link budget, than communication links in lower frequency communication links, such as links of the 2.4 GHz and 5 GHz bands. mmWave communication links have inherent isolation due to both oxygen absorption, which attenuates the signal over a long range, and short wavelength, which provides high attenuation through obstructions such as walls and ceilings. Many mmWave networks may employ directional antennas for high speed point-to-point data transmission. mmWave network devices performing directional transmissions may achieve higher ranges, which may require mitigation for link budget issues, as well as better aggregated throughput and spatial reuse, wherein certain transmitter-receiver (TX-RX) pairs of devices separated in space in the network may communicate simultaneously.

The high gain of the directional antennas may enable signal-to-noise ration (SNR) margins over very wide bandwidth (^{˜}2 GHz) with limited (^{˜}10 dBm) transmitted power. Also the implementation of the small size high gain antennas is feasible for 60 GHz WPAN devices because of the small wavelength (5 mm). The propagation characteristics of the 60 GHz channel are close to the quasi-optical characteristics and thus the directional transmission between TX-RX pair generally has a low probability to interfere with the other directional TX-RX pair transmissions. However, as the number of mmWave networking devices in a particular area increases, the probability of interference increases. Further, the mmWave networking devices may employ different types of antennas that may increase the likelihood of interference. For example, a device may employ a directional antenna pattern covering a wide range of angles to give omni-directional coverage, which may aid in neighbor discovery and beam-steering decisions. Even further, mmWave networking devices may employ other types of antennas, such as non-trainable antennas, sectorized antennas, and phased array antennas, as examples.

Some embodiments may provide an mmWave network system based on IEEE 802.15.3 and IEEE 802.15.3b specifications. Some embodiments may employ parallel data transmission, such as spatial reuse or Spatial Division Muitiple Access (SDMA). According to IEEE 802.15.3 and current IEEE 802.15.3c proposals, the basic WPAN network is called piconet and is composed of the piconet controller (PNC) and one or more communication devices (DEVs). The PNC may alternatively be referred to as the piconet coordinator, or simply as the controller or coordinator.

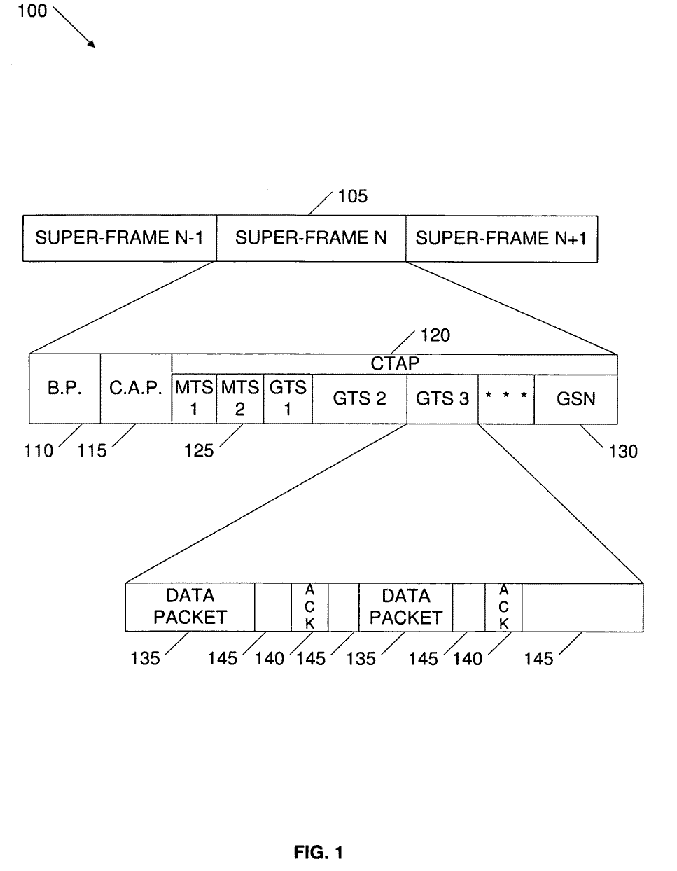

In a traditional mmWave network, the coordinator may schedule the channel time using Time Division Multiple Access (TDMA) technology that generally does not support parallel transmissions. Any device that may interfere with devices within a specific mmWave network may be controlled by the same coordinator. The coordinator may usually perform channel time reservations for each super-frame, which is the basic timing division for TDMA, and communicate the time reservations via a beacon frame or beacon period. How a coordinator may communicate the time reservations to coordinate the transmissions of the different mmWave networking devices is illustrated in more detail in FIG. 1.

FIG. 1 illustrates a data transmission scheme 100 in which information may be transmitted through a wireless mmWave network, including a plurality of media access control (MAC) super-frames 105. Each super-frame may include numerous time slots. Super-frame 105 may be of a set length to allow various devices in the network to coordinate with a network controller or other devices in the network. As shown in FIG. 1, data transmission scheme 100 includes transmitting successive super-frames 105 in time over a network. Each super-frame 105 includes a beacon period 110, an optional contention access period (CAP) 115, and a Channel Time Allocation Period (CTAP) 120. CTAP 120 may include one or more management time slots 125 and one or more time slots 130.

Super-frame 105 may comprise a fixed-time construct that is repeated in time. The specific duration of the super-frame 105 may be described in beacon period 110. In an embodiment, beacon period 110 may include information regarding how often beacon period 110 is repeated, which may effectively correspond to the duration of super-frame 105. Beacon period 110 may also contain information regarding the mmWave network, such as the identity of the transmitter-receiver pair of each slot, and the identity of the controller or coordinator.

In an embodiment, the coordinator may use beacon period 110 to transmit the management information to the different mmWave networking devices. There may be beacon frames common to all devices and also beacon frames dedicated to specific devices (which may be transmitted in the directional mode). All such frames may be transmitted within beacon period 110. CAP 115 may be used for random contention-based access and used for MAC commands, acknowledgements, and data frame transmissions. CTAP 120 may usually comprise the largest part of super-frame 105 and be divided by the coordinator into time slots allocated for data transmission between different nodes (DEVs) in the TDMA manner so that only the one transmission occurs at a time.

A coordinator may use beacon period 110 to coordinate the scheduling of the different mmWave networking devices to use their respective time slots 130. The different mmWave networking devices may listen to the coordinator during beacon period 110. Each device may receive zero or more time slots 130, being notified of each start time and duration from the coordinator during beacon period 110. Channel time allocation (CTA) fields in beacon period 110 may include start times, packet duration, source device identification (ID), destination device ID, and a stream index. The beacon information may use what is often called TLV format, which stands for type, length, and value. As a result, each device knows when to transmit and when to receive. Beacon period 110, therefore, may be used to coordinate the transmitting and receiving of the different mmWave networking devices.

Individual devices may transmit data packets during CTAP 120. The devices may use the time slots 130 assigned to them to transmit sub-slot data packets 135 to other devices. Each device may send one or more packets 135 of data, and may request an immediate acknowledgement (ACK) frame 140 from the recipient device indicating that the packet was successfully received, or may request a delayed (grouped) acknowledgement.

In a high-density enterprise environment, the position of an individual device, the antenna type, and the orientation of the device determine the level of interference experienced by the device. With mm-Wave specifically, there is substantial use of (controlled) directed antennas so that in a slot-time of a transmission from station-A to station-B, each of the two, may direct its antenna towards its partner. Station-B may suffer interference for reception of a packet from Station-A, while during the same time slot station-B may see no interference for reception of packet from station-C. As a result, the capability of different devices to successfully receive transmissions may vary over time as well as vary per the specific plan, as interference of a receiver may be specific-source dependent. In TDMA systems, the super-frame schedules may tend to follow repeated patterns. Consequently, the interference due to neighboring wwWave networks may be predicted, to a certain extent, for each channel time block.

In various embodiments, a coordinator of an mmWave network may schedule transmissions in a way that minimizes the level of interference based on reports from the receivers of each TX-RX pair in the mmWave network. In other words, the coordinator may be able to predict future interference from neighboring networks based on perceived interference signatures of the various receivers and coordinate the transmissions so as to avoid the interference. When the interfering device is transmitting constant bit rate (CBR) traffic, the coordinator may use a fixed routine to schedule traffic, which may be repeated between super-frames, to protect devices within the mmWave network of the coordinator from the interference.

Unfortunately, mmWave networks that have devices which transmit data using a variable bit rate (VBR) present a challenge for coordinators attempting to schedule traffic that avoids interference. When a device transmits VBR data, the coordinator of the associated network locks or reserves all needed sub-slots to enable the maximum needed rate. However, many of the slots and/or sub-slots may be rarely used. Consequently, receiving devices of neighboring networks that attempt to develop an accurate noise signature may not sense any usage of the rarely used sub-slots of the VBR device. Missing the slots and sub-slots when developing the interference signature may cause certain devices, such as compressed wireless displays, may perform poorly when the VBR uses the rarely used sub-slots and causes interference. In this scenario, the mmWave network may generally benefit more from a higher quality of service than from maximizing reuse of the vacant channel time.

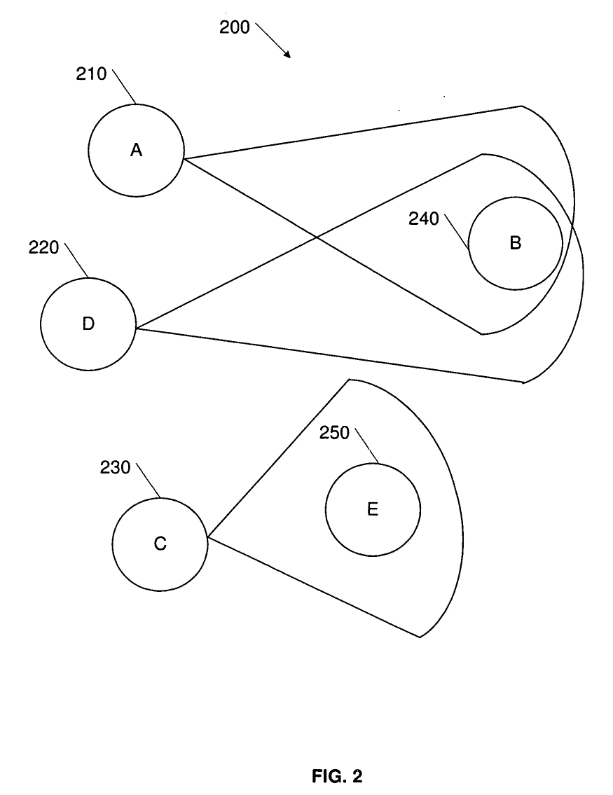

For a coordinator to prevent interference in an environment having one or more VBR sources, an embodiment may employ an interference mitigation scheme that allows the coordinator to gather more accurate interference signatures from the receiving devices. The coordinator may use the more accurate interference signatures to schedule transmissions in such a way that minimizes or mitigates the interference experienced by one or more of the various receivers. FIG. 2 illustrates how an embodiment may employ an interference mitigation scheme in an mmWave network.

FIG. 2 has an mmWave network 200 that may comprise, e.g., a WPAN. mmWave network 200 may have a number of unidirectional links, each link comprising a TX-RX pair of devices. For example, mmWave network 200 has a first unidirectional link between receiving device 240 and transmitting device 210, a second unidirectional link between receiving device 240 and transmitting device 220. Further, a third unidirectional link may exist between receiving device 250 and transmitting device 230, but these devices may be in a neighboring network separate from mmWave network 200. In other words, receiving device 250 and transmitting device 230 may be under the control of a separate coordinator different from the devices of mmWave network 200. A device may participate in multiple links, as FIG. 2 illustrates with receiving device 240.

To allocate channel time blocks to the links in a manner to mitigate interference from VBR sources, a coordinator may identify the interference level, or interference signature, at each of the receiving devices on a per-link basis. For each link in a system, the receiver may inform the coordinator about the interference level, which may comprise noise strength or power, experienced during all channel time blocks except the ones in which the link is active or scheduled for transmission.

In mmWave network 200, the coordinator may generate an interference signature for receiving device 240 for all channel time blocks that receiving device 240 is not scheduled to exchange data between transmitting device 210 or transmitting device 220. Based on the interference signature developed by receiving device 240, the coordinator may employ a set of scheduling rules to develop a schedule for the transmission of data from transmitting device 210 and transmitting device 220 to receiving device 240. More broadly stated, the coordinator of mmWave network 200 may use interference signatures developed by the receiving devices of mmWave network 200 to coordinate the transmission of data from the transmitting devices of mmWave network 200 in a manner that mitigates or avoids interference from the transmissions of neighboring networks.

The interference-report of receiving device 240 may include a separate information element or a report-set for interference based on its antenna directivity. For example, receiving device 240 may have an interference set of report for a case of having its antennas pointing towards transmitting device 210 and a spate report for a case of having its antennas pointing towards transmitting device 220. It is also possible to look at re-use within same network. The coordinator may provide permission for parallel transmission as the same time. This parallel use may have a directivity nature and may be based on the report from receivers. In this case, there may be an “in-network” interference scheme. The coordinator may have another level of information. The additional level of information may help in creating the transmission plan, via a potential detection of inner-network interference dependencies. In another words, the mechanisms that are defined for the ability to provide cross network interference mitigation may be used as in-network solution or as part of in-network re-use solution. At the same time, while those mechanisms are defined in a distributed way with no need for cross network communication for coordination, the extra information may be used.

As alluded to earlier, a potential issue that may arise in developing an interference signature by a receiving device stems from the fact that a neighboring network may have a transmitting device that transmits data using a VBR. Having the VBR transmitting device in the network of the coordinator may not cause a problem, even though many of the sub-slots may be rarely used, because the coordinator of the associated network is aware of the VBR usage and may prevent data transmissions from the other devices during all the associated sub-slots associated with the VBR transmitting device.

Unfortunately, the coordinators of neighboring networks are not necessarily aware of potential usage of the rarely used sub-slots of VBR transmitting devices. Missing the rarely used sub-slots when developing the interference signature may cause a problem when the VBR transmitting device subsequently uses the sub-slots, as the coordinator may have scheduled transmission from a transmitting device of its network during a period which overlaps one or more of the sub-slots. To mitigate the interference of VBR transmissions, an embodiment may define behavior rules for each transmitter of VBR traffic that enables receiving devices to develop more accurate interference signatures. How an embodiment may enable receiving devices to develop more accurate interference signatures can be illustrated by way of an example with reference to FIG. 2.

Suppose that transmitting device 230 transmits data to receiving device 250 using a VBR flow. Suppose further that the VBR flow requires 128 slots, overall, to satisfy the maximum throughput requirement. The coordinator of the network comprising transmitting device 230 and receiving device 250 may use a constant allocation of sub-slots 33-96 and 161-224. The constant allocation by the coordinator may be part of enabling receivers to develop more accurate interference signatures.

The VBR flow from transmitting device 230 to receiving device 250 may typically consume much less than the allotted 128 sub-slots. For example, transmitting device 230 may typically use only 16 sub-slots of the 128 sub-slot total. If transmitting device 230 were to use a constant allocation of sub-slots out of the total allotment, such as sub-slots 33-40 and 161-168, a remote receiving device that monitors the channel for transmissions or noise when developing an interference signature will fail to identify the interference signature for the periods associated with the rarely used sub-slots, 41-96 and 169-224.

To develop a more accurate interference signature, an embodiment may cause a transmitting device to use each sub-slot at least once per a predetermined number of transmit-units or beacon periods. In other words, an embodiment may cause each sub-slot to be used at least once in a predetermined amount of time. Causing each sub-slot to be used periodically may enable a receiving device to develop a noise signature for the predetermined amount of time.

How a transmitting device will periodically use each sub-slot may vary from embodiment to embodiment. In an example embodiment, a transmitting station may transmit data during allocated sub-slots in a sporadic way, using different sub-slots during each transmit-unit. For example, transmitting device 230 may transmit data using sub-slots 33-40 and 161-168 during a first beacon period, transmit data using sub-slots 41-48 and 169-176 during a second beacon period, and so on until transmitting data using all of the sub-slots for both the first range of 33-96 and the second range of 161-224.

An alternative embodiment may monitor the transmission of data for a specific period, such as six beacon periods. During the next few beacon periods, the embodiment may purposefully transmit data on the previously unused sub-slots of the specific period. For example, if the embodiment has transmitted data via sub-slots 33-96 and 161-195 during the six previous beacon periods, the embodiment may transmit data via the remaining sub-slots 196-224 during the next two beacon periods. If the embodiment does not have sufficient actual data to transmit, the embodiment may supplement the data stream with null data.

An even further alternative embodiment may not monitor the usage during specific sets of beacon periods but merely append null data to the traffic stream periodically. For example, an embodiment may transmit real application data during beacon periods 1 through 3, yet on the 4th beacon period transmit actual data but append null data to fill up any of the remaining sub-slots of 33-96 and 161-224. In other words, some embodiments may just transmit null data or other data in order to ensure creation of an interference signature.

As one skilled in the art will appreciate, alternative embodiments may transmit data in a variety of different fashions, over a variety of specific periods to ensure creation of interference signatures by the receiving devices. For example, in some embodiments, the transmit-unit may be four beacon periods. In other embodiments, the transmit-unit may be eight beacon periods, or some other number of beacon periods. Some embodiments may not be specifically linked to beacon periods but instead be related to a predetermined period of time. Some embodiments may transmit null data to occupy the sub-slots. Other embodiments may transmit other types of data, such as synchronization data or diagnostic data. As one will appreciate, the combinations and variations for alternative embodiments are innumerable.

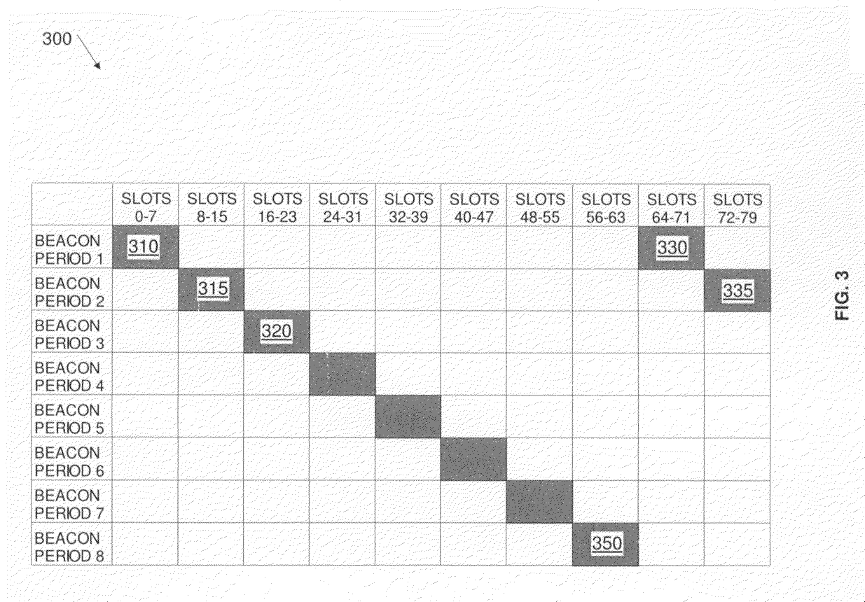

FIG. 3 illustrates how a transmitter may transmit data for a sub-slot allocation 300 in an example embodiment. The coordinator may have allocated sub-slots 0-79 to the transmitter to accommodate the maximum use of the VBR flow. However, the transmitter may not continually need all 80 sub-slots. To enable a receiver to develop an accurate interference signature, the transmitter may use only part of the sub-slots and use different ones each beacon period. For example, the transmitter may transmit data during each of the sub-slots in a sequentially manner during sequential beacon periods.

The transmitter may transmit data via sub-slots 0-7 and sub-slots 64-71 during beacon period 1 (elements 310 and 330), transmit data via sub-slots 8-15 and sub-slots 72-79 during beacon period 2 (elements 315 and 335), transmit data via sub-slots 16-23 during beacon period 3 (element 320), and so on until transmitting data via sub-slots 56-63 during beacon period 8 (element 350). Consequently, a receiver may efficiently detect an interference signature that includes all sub-slots within a known period of time (eight beacon periods for the example illustrated via FIG. 3).

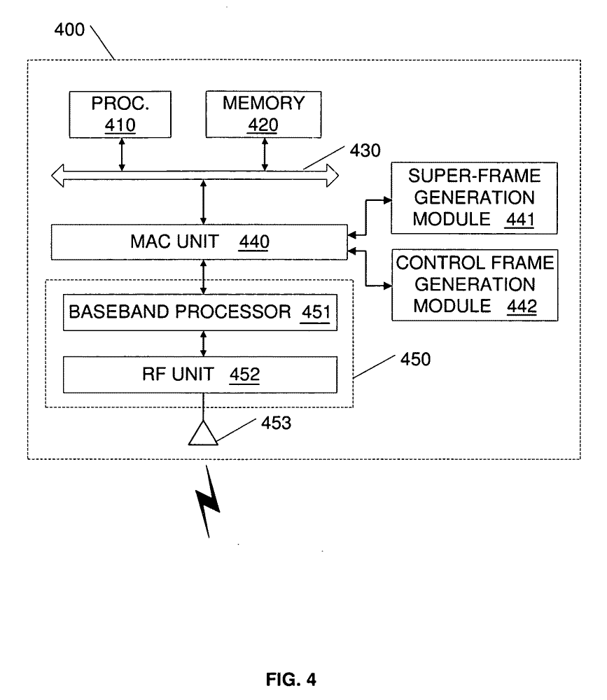

Turning now to FIG. 4, there is shown an embodiment of a network coordinator 400 according to an exemplary embodiment. For example, network coordinator 400 may comprise a device that transmits VBR data which interferes with a receiver in an mmWave network. Network coordinator 400 may include a processor 410, a memory module 420, a MAC unit 440, a physical layer (PHY) unit 450, a super-frame generation module 441, a control frame generation module 442, and an antenna 453.

Processor 410 may control other components connected to a bus 430, including components of an upper layer of MAC unit 440. In other words, processor 410 may process a received MAC service data unit (MSDU) from MAC unit 440 or generate a transmitted MSDU and provide it to MAC unit 440. Processor 410 may control the other components connected to bus 430 in a manner that facilitates transmission of data during sub-slots allotted to network coordinator 400 and enables generation of an interference signature when the network coordinator 400 would otherwise not use all allotted sub-slots during the period specified for development of the interference signature.

Memory module 420 may temporarily store received MSDUs or MSDUs generated for transmission. For example, memory module 420 may store generated MSDUs until transmission in sequentially selected sub-slots of sequential beacon periods. In other words, memory module 420 may store data until the data is transmitted from network coordinator 400 during one or more sub-slots in a manner that enables creation of an interference signature.

Memory module 420 may comprise a non-volatile memory device, such as a read-only memory (ROM), a programmable read-only memory (PROM), an erasable programmable read-only memory (EPROM), an electronically erasable programmable read-only memory (EEPROM), a flash memory. Memory module 420 may also comprise a volatile memory device, such as a random-access memory (RAM), or a storage media such as a hard disk and an optical disk, or other forms well known in the related art.

MAC unit 440 may append a MAC header to the MSDU provided from processor 410, e.g., multimedia data-to-be-transmitted, and generate a MAC protocol data unit (MPDU). MAC unit 440 may transmit the MPDU to PHY unit 450, and erase the MAC header from the MPDU transmitted via PHY unit 450.

As described above, the MPDU transmitted by MAC unit 440 may include a super-frame that is transmitted during a beacon period. The MPDU transmitted by MAC unit 440 may include an association-request frame, a data-slot-request frame, and a variety of control frames. Super-frame-generation module 441 may generate one of the super-frames, described with reference to FIG. 1, and provide the super-frame to MAC unit 440. Control frame generation module 442 may generate the association-request frame, the data-slot-request frame, and other control frames and provide these to MAC unit 440. Super-frame-generation module 441 and control frame generation module 442 may be configured in a manner which allows network coordinator 400 to transmit data in each sub-slot of the allotment of sub-slots for the VBR data. Further, in some embodiments, super-frame generation module 441 and control frame generation module 442 may be configured to generate frames which enable network coordinator 400 to transmit null data in one or more sub-slots of the allotment.

PHY unit 450 may append a signal field or a preamble to the MPDU provided by MAC unit 440 to generate a PPDU. The generated PPDU, i.e., the data frame, may be converted into a signal, and transmitted through antenna 453 during the time of a sub-slot. PHY unit 450 may be further divided into a baseband processor 451 that processes a baseband signal and a radio frequency (RF) unit 452 that generates a radio signal from the baseband signal and transmits it via antenna 453. More specifically, baseband processor 451 may format the frames and code the channels, while the RF unit 452 may amplify analog signals, convert digital signals into analog signals or vice versa, and modulate the signals for transmission. PHY unit 450 may operate in a manner which enables transmission of data in each sub-slot of the allotment of sub-slots for the VBR data.

In some embodiments system 400 may comprise a computer system in an mmWave network, such as a notebook or a desktop computer. In other embodiments system 400 may comprise a different type of computing and wireless receiving apparatus in an mmWave network, such as a palmtop computer, a personal digital assistant (PDA), or a mobile computing device, as examples.

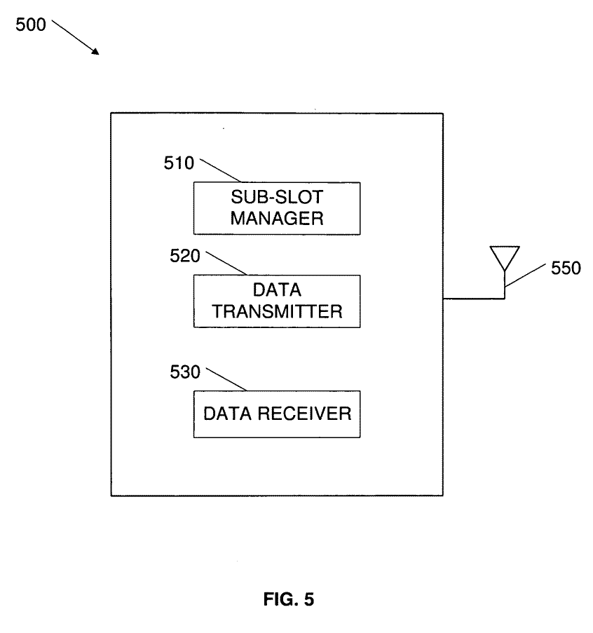

FIG. 5 depicts one embodiment of an apparatus 500 that may transmit VBR data in such a manner that enables generation of more accurate interference signatures for receiving devices in an mmWave network. Generation of the more accurate interference signatures may improve interference mitigation in the network. One or more elements of apparatus 500 may be in the form of hardware, software, or a combination of both hardware and software. For example, in the embodiment depicted in FIG. 5, the modules of apparatus 500 may exist as instruction-coded modules stored in a memory device. For example, the modules may comprise software or firmware instructions of an application, executed by a processor of a network interface card (NIC), wherein the NIC is part of a computing system configured to communicate in a 60 GHz network. In other words, apparatus 500 may comprise elements of a station in a wireless network.

In alternative embodiments, one or more of the modules of apparatus 500 may comprise hardware-only modules. For example, sub-slot manager 510 and data transmitter 520 may both comprise a portion of an integrated circuit chip, coupled to antenna 550, comprising memory elements and a state machine, in a computing device. In such embodiments, the memory elements of sub-slot manager 510 may work in conjunction with the state machine of data transmitter 520, scheduling and buffering data until data transmitter 520 transmits the data in sub-slots of an allotment.

Apparatus 500 may be configured to transmit VBR data during an allotment of sub-slots. For example, apparatus 500 may comprise an element of transmitting device 230. Transmitting device 230 may be connected or associated with a mmWave network located adjacent to another mmWave network to which transmitting devices 210 and 220, as well as receiving device 240, are associated. Being a VBR device, apparatus 500 may vary the amount of data transmitted per time segment. For example, the time segment may be the duration of a sub-slot, with each sub-slot in a frame or super-frame having a specific duration. Apparatus 500 may transmit a certain number of kilobytes of data during one sub-slot, but transmit a greater amount or a lesser amount of kilobytes during another sub-slot.

Once apparatus 500 has associated with or created a network communication link with the coordinator of its mmWave network, the coordinator may provide apparatus 500 with an allotment of sub-slots. By way of illustration, the coordinator may communicate with apparatus 500, instructing apparatus 500 to use a total of 64 sub-slots, overall, to satisfy the maximum throughput requirement that apparatus 500 requires. The coordinator may reserve a constant allocation of sub-slots 33-64 and 193-224.

Even though apparatus 500 may periodically need 64 sub-slots to satisfy a maximum throughput requirement, the VBR flow from apparatus 500 may typically consume less than the allotted 64 sub-slots. In other words, the transmission demand of apparatus 500 may be less than the capacity of all 64 sub-slots of the allotment during a succession of many beacon periods. For example, apparatus 500 may typically use only 16 sub-slots of the 64 sub-slot allotment. However, when an application of apparatus 500 requires greater throughput, apparatus 500 may transmit data using all 64 sub-slots of the allotment during one or more super-frames.

A remote receiving device, such as receiving device 240, may monitor the channel for transmissions or noise and attempt to develop an interference signature. However, if apparatus 500 were to routinely use only a small number of sub-slots out of the total allotment, receiving device 240 may not identify the interference signature for the periods associated with the rarely used sub-slots. For example, apparatus 500 may routinely use only sub-slots 33-40 and 193-200. Consequently, when developing an interference signature, the receiving device may not develop an accurate interference signature for the periods of time related to sub-slots 41-64 and 201-224. To enable the receiving device to develop a more accurate interference signature or noise pattern of the communications channel, apparatus 500 may transmit data during each of the sub-slots 33-64 and 192-224 over a predetermined period of time via sub-slot manager 510.

In order to transmit data during each of the sub-slots, sub-slot manager 510 may monitor and track the usage of the sub-slots in the allotment for apparatus 500. Upon communicating with the coordinator and establishing which slots that apparatus 500 is to use when transmitting data, sub-slot manager 510 may note which sub-slots that apparatus should use over time in order assure that all sub-slots are periodically used. For example, sub-slot manager 510 may comprise a processor and memory. Sub-slot manager 510 may execute instructions that create a table or list for each of the sub-slots in the memory.

For each of the sub-slots that sub-slot manager 510 uses to transmit data during a beacon period, sub-slot manager 510 may set a bit to track usage of each sub-slot. During the next beacon period, sub-slot manager 510 may determine which sub-slots have already been used and start using the next-available set of sub-slots to transmit data. Continuing with the example above, sub-slot manager 510 may work in conjunction with data transmitter 520 to transmit data during sub-slots 33-40 and 193-200 during one beacon period. Upon successfully transmitting the data, sub-slot manager 510 may set bits in the table for entries corresponding to sub-slots 33-40 and 193-200. During the next beacon period, sub-slot manager may transmit data during sub-slots 41-48 and 201-208 and mark the entries in the table accordingly. Sub-slot manager 510 may continue determining which sub-slots have already been used and using the next-available set of sub-slots to transmit data until all slots have been used.

Causing data transmitter 520 to transmit data during each of the sub-slots of the allotment over a predetermined period of time may enable any receiving devices within interference range of apparatus 500 to create interference signatures for a predetermined period. The duration and measure of the predetermined period may vary from embodiment to embodiment. For example, in the example of the embodiment described above, the duration of the predetermined period may equal four beacon periods, wherein the measure would be in beacon periods. One beacon period to transmit data during sub-slots 33-40 and 193-200, a second beacon period to transmit data during sub-slots 41-48 and 201-208, a third beacon period to transmit data during sub-slots 49-56 and 209-216, and a fourth beacon period to transmit data during sub-slots 57-64 and 217-224.

In another embodiment, measurement of the predetermined period may not be in beacon periods, but in units of time. For example, the measurement may be in seconds, with the duration of the predetermined period equaling 5 seconds in one embodiment or 800 milliseconds in another embodiment. The duration of the predetermined period may vary according to the embodiment. As one skilled in the art will appreciate, having a predetermined period measured in units of time instead of beacon periods or super-frames may cause the end of a predetermined period to fall in the middle of a super-frame period. In such embodiments, sub-slot manager 510 may ensure that all slots are used within the predetermined period by, e.g., employing a clock to track the progression of the predetermined period.

Sub-slot manager 510 may track both the time and the sub-slot usage differently in different embodiments. For example, at the beginning of a predetermined period sub-slot manager 510 may set the usage bits for all sub-slots to zero and reset a beacon period counter. As sub-slot manager 510 employs data transmitter 520 to transmit data in sub-slots of the allotment, sub-slot manager 510 may change the status of the usage bits from zero to one. As the beacon periods elapse, sub-slot manager 510 may increment the beacon period counter. If all of the sub-slots of the allotment are used before the beacon period counter reaches the predetermined count value, sub-slot manager 510 may leave the usage bits set to one but continue cycling through various sub-slots as needed until the beacon period counter reaches the count value.

Alternatively, in another embodiment, sub-slot manager 510 may reset the beacon period counter to zero and reset all of the usage bits back to zero when all of the sub-slots of the allotment are used before the beacon period counter reaches the predetermined count value. In other words, once sub-slot manager 510 has determined that all of the sub-slots have been used within the predetermined period, sub-slot manager 510 may reset the cycle to ensure that all sub-slots are used during the next predetermined period.

In a further alternative embodiment, sub-slot manager 510 may set the usage bits for all sub-slots to zero and reset a counter that receives an increment signal from a clock signal of apparatus 500. As sub-slot manager 510 employs data transmitter 520 to transmit data in sub-slots of the allotment, sub-slot manager 510 may change the status of the usage bits from zero to one. As time elapses, the counter may increment toward a predetermined counter value which corresponds to the end of the predetermined period. If all of the sub-slots of the allotment are used before the beacon period counter reaches the predetermined count value, sub-slot manager 510 may leave the usage bits set to one but continue cycling through various sub-slots as needed until the counter reaches the predetermined counter value.

As the end of the predetermined period approaches, sub-slot manager 510 may determine that all of the sub-slots in the allotment have not been used and will not be used to transmit actual data before the end of the predetermined period. Consequently, sub-slot manager 510 may transmit null data during the unused sub-slots. For example, the predetermined period may be ten beacon periods. Upon transmitting data during the ninth beacon period, sub-slot manager 510 may determine that sub-slots 33-64 have all been used to transmit data during beacon periods 1-9. Sub-slot manager 510 may transmit both actual and null data using sub-slots 193-224 during the tenth beacon period to fulfill the requirement of using all sub-slots during the predetermined period.

In some situations or operating scenarios, apparatus 500 may have periods in which no data needs to be transmitted for one or more super-frames or beacon periods. Different embodiments may be configured to respond differently in such a scenario. Many embodiments may seize the opportunity to transmit null data. For example, sub-slot manager 510 may determine that half of the predetermined period has elapsed, but only 20% of the sub-slots have been used. Sub-slot manager 510 may transmit null data during, e.g., 30%-60% of the unused sub-slots during the beacon period that otherwise would have no data transmitted.

As one skilled in the art will appreciate, different embodiments may be configured to respond in an almost countless variety of ways. For example, in some embodiments, sub-slot manager 510 may track the average sub-slot usage of the allotment over several predetermined periods to determine the average sub-slot usage. During subsequent predetermined periods sub-slot manager 510 may transmit null data during some sub-slots during the beacon periods to ensure that all sub-slots have been used to transmit data by the end of the predetermined period.

For example, sub-slot manager 510 may determine that the average sub-slot usage is 30%. Consequently, sub-slot manager 510 may multiply the number of slots of the allotment by 0.70 and divide the resulting product by the number of beacon periods in the predetermined period. Sub-slot manager 510 may then transmit null data for the resulting number of slots in order to average out the transmission of null data. For example, an embodiment may have an allotment of 100 sub-slots, with the predetermined period equaling 10 beacon periods and an average sub-slot usage equaling 30 sub-slots. Sub-slot manager 510 may multiply 0.70 (70% unused) by 100 to arrive at 70 sub-slots. Sub-slot manager 510 may divide the 70 sub-slots by 10 and consequently transmit null data in 7 sub-slots of the allotment, in addition to the actual data, during each beacon period.

As noted, sub-slot manager 510 may comprise a processor and memory. In alternative embodiments, sub-slot manager 510 may not comprise a processor, per se, but instead comprise another type of device, such as a state machine coupled with dynamic random access memory. Data transmitter 520 may comprise hardware configured to accept data from sub-slot manager 510, prepare the data for transmission, and transmit the data via antenna 550. For example with reference to the embodiment of FIG. 4, data transmitter 520 may comprise MAC unit 440, PHY unit 450, super-frame-generation module 441 and control frame-generation module 442, as well as other modules.

In some embodiments, apparatus 500 may be able to transmit data and receive data. In other words, apparatus 500 may comprise part of a transceiver networking device, wherein data receiver 530 is also coupled to antenna 550 or another antenna. In such an embodiment, sub-slot manager 510 may work in conjunction with data receiver 530 to monitor sub-slot usage of the channel and develop an interference signature. In such an embodiment, sub-slot manager 510 may be configured to create the interference signature and transmit the interference signature to a coordinator, thereby enabling the coordinator to schedule transmissions for other receivers in the mmWave network.

In other embodiments, sub-slot manager 510 may be configured to transmit data to a coordinator to enable the coordinator to create the interference signature. In other words, apparatus 500 may not create the interference signature but transmit interference data to the coordinator which enables the coordinator to develop the interference signature. For example, after each beacon period apparatus 500 may inform the coordinator as to which sub-slots that apparatus 500 sensed data and/or noise on the communications channel. The coordinator may track such interference data for each receiver over a number of beacon periods and develop interference signatures for each receiver.

In many embodiments, sub-slot manager 510 may be configured to disable the transmission of data during each of the sub-slots of the allotment if the environment of the mmWave network is a low data density environment. For example, the operation of apparatus 500 may be configurable via a web interface screen of a browser window. The owner of the apparatus may be placing apparatus 500 in a home network environment that has relatively little interference. The owner may click on an item of the interface screen which enables a configuration application to disable program routines and/or circuitry that would otherwise operate to ensure usage of the sub-slots of an allotment.

In some embodiments, sub-slot manager 510 may be configured to dynamically change the assignment of sub-slots of the allotment to accommodate changes of application demands of apparatus 500. For example, apparatus 500 may comprise a laptop with a 60 GHz networking device. A user of the laptop may transmit audio and video information to a wireless television. In the middle of the movie, the user may change the display resolution from, e.g., 720p to 1080i. The maximum throughput requirement for 720p may have been much lower than the maximum throughput requirement for 1080i. Consequently, when the user changes the resolution setting, sub-slot manager 510 may dynamically increase the number of sub-slots for the allotment to accommodate the additional needs of the multimedia application. Associated with the change in sub-slot allotment, apparatus 500 may dynamically adjust and ensure that all sub-slots of the new allotment are used within the predetermined period. The alternative embodiment may also be able to dynamically decrease the sub-slot allotment size.

The number of modules in an embodiment of apparatus 500 may vary. Some embodiments may have fewer modules than those module depicted in FIG. 5. For example, one embodiment may integrate the functions described and/or performed by data transmitter 520 with the functions of data receiver 530 into a single module. Further embodiments may include more modules or elements than the ones shown in FIG. 5. For example, alternative embodiments may include two or more sub-slot manage modules, or additional modules not shown, such as a beacon tracking module, a channel monitoring module, a clock monitoring module, and so on. One having ordinary skill in the art that the number of modules and the functions performed by the modules may change depending on the usage application.

Apparatus 500 may comprise a component in a station of an 802.11ad wireless communication network. By default, stations of a wireless LAN may operate in a Constant Access Mode (CAM) which means that the stations are always on listening for traffic. To save power, such as when a system containing apparatus 500 comprises a battery-powered device like a hand-phone or other portable device, apparatus 500 may enter a sleep mode to conserve power. However, to ensure that an accurate interference signature is developed by neighboring receiving devices, apparatus 500 may be configured to wake up periodically and transmit null data for all of the sub-slots of the allotment before going back to sleep.

Further, an alternative system comprising apparatus 500 may enter a sleep mode called Polled Access Mode (PAM) without losing frames. In PAM, a 60 GHz access point may buffer packets due for apparatus 500 until the system comes out of sleep mode. The access point may send out the information on which the system and other stations have frames due to them within frames called Traffic Information Maps (TIM). A client may receive the TIMs and wake just long enough to receive whatever frames have been buffered for the client before the client goes back to sleep. If broadcast traffic is available then the access point may send a Delivery Traffic Information Map (DTIM). To ensure that accurate interference signatures are developed in such an alternative system, apparatus 500 may be configured to wake up periodically and transmit null data for all of the sub-slots of the allotment before going back to sleep.

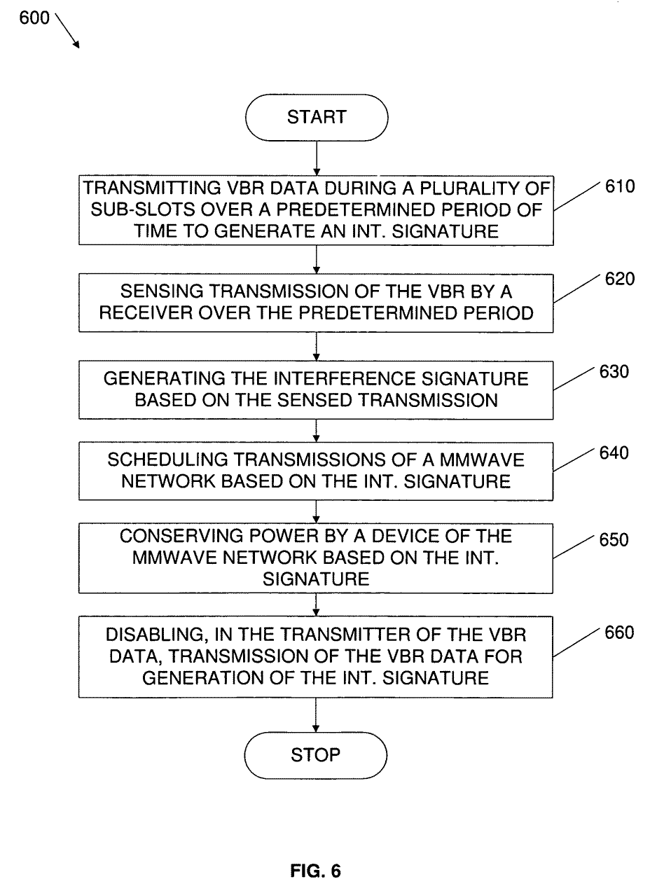

FIG. 6 illustrates a process 600 of transmitting VBR data to develop an accurate interference signature in an mmWave network. In an embodiment, a transmitting device, such as a wireless network card of a notebook computer, may transmit VBR data during a plurality of sub-slots during a predetermined period of time to enable generation of an interference signature (element 610). For example, apparatus 500 may be allotted sub-slots 33-96 and 161-224 to transmit the VBR data. Over a period of six beacon periods, sub-slot manager 510 may ensure that data transmitter 520 transmits data during each sub-slot of sub-slots 33-96 and 161-224.

A receiving device located in a neighboring mmWave network may sense transmission of the VBR data, or at least noise of the communication channel related to the transmission, during each of the sub-slots of the plurality over the predetermined period of time (element 620). Upon sensing the interference based on the transmission, an embodiment may generate the interference signature based on the sensed transmission (element 630). For example, the receiving device may monitor the channel for a predetermined period equaling six beacon periods. For each sub-slot of each beacon period monitored, the receiving device may track and generate the interference signature by setting bits for the sub-slots that the receiving device sensed was used during six consecutive beacon periods.

Upon generating the interference signature, the receiving device may transmit the interference signature to the coordinator of the network, enabling the coordinator to schedule transmissions of the receiver and mitigate interference from the transmitter. In alternative embodiments, the receiving device may not generate the interference signature. For example, the receiving device may monitor the channel during each beacon period, determine which sub-slots have noise or interference, and transmit the sub-slot usage information to the coordinator during the subsequent beacon period. In other words, the receiver may send the sub-slot usage information to the coordinator, whereupon the coordinator may assemble the interference signature for the receiver.

Whichever device generates the interference signature, the receiving device or the coordinator, the coordinator may use the interference signature when scheduling transmissions for the various receiving devices (element 640). To mitigate interference for a receiving device, the coordinator may schedule transmissions for sub-slots where the interference signature indicates no interference was sensed.

In many embodiments, one or more devices in the mmWave network may be able to conserve power based on the interference signature(s) (element 650). For example, upon developing the interference signature, transmitting the interference information to the coordinator, and receiving the assigned allotment of sub-slots conserving, the receiving device may disable one or more circuits during periods the receiving device is not scheduled for transmission. The receiving device may turn off transmitting and/or receiving circuits, or possibly enter a sleep mode temporarily until the scheduled times of transmissions and/or receptions. In other words, the receiving device may conserve power during periods of inactivity based on the transmission schedule. Further, in alternative embodiments, the coordinator may determine the power conservation periods for one or more devices in the mmWave network and communicate the conservation period information to the devices.

In numerous embodiments, the transmitting device may have the ability to disable or bypass the interference signature generation feature (element 660). For example, when the feature is disabled the transmitting device may transmit VBR data using only the sub-slots on the lower end of the allotment, instead of ensuring that all sub-slots are used during the predetermined period. The transmitting device may automatically disable the interference signature generation feature when the transmitting device continually senses that the channel has little or not interference. Alternatively, a user of the transmitting device may disable the feature by, e.g., setting a parameter during a setup routine.

Another embodiment is implemented as a program product for implementing systems and methods described with reference to FIGS. 1-6. Embodiments can take the form of an entirely hardware embodiment, an entirely software embodiment, or an embodiment containing both hardware and software elements. One embodiment is implemented in software, which includes but is not limited to firmware, resident software, microcode, etc.

Furthermore, embodiments can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include compact disc-read only memory (CD-ROM), compact disc-read/write (CD-R/W), and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem, and Ethernet adapter cards are just a few of the currently available types of network adapters.

The logic as described above may be part of the design for an integrated circuit chip. The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher level carrier) or in a multichip package (such as a ceramic carrier that has either or both surface interconnections or buried interconnections). In any case, the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

It will be apparent to those skilled in the art having the benefit of this disclosure that the present disclosure contemplates transmitting VBR data in a manner to generate interference signatures receiving devices of a wireless mmWave network. It is understood that the form of the embodiments shown and described in the detailed description and the drawings are to be taken merely as examples. It is intended that the following claims be interpreted broadly to embrace all variations of the example embodiments disclosed.

Although the present disclosure has been described in detail for some embodiments, it should be understood that various changes, substitutions, and alterations can be made herein without departing from the spirit and scope of the disclosure as defined by the appended claims. Although specific embodiments may achieve multiple objectives, not every embodiment falling within the scope of the attached claims will achieve every objective. Moreover, the scope of the present application is not intended to be limited to the particular embodiments of the process, machine, manufacture, composition of matter, means, methods, and steps described in the specification. As one of ordinary skill in the art will readily appreciate from this disclosure, processes, machines, manufacture, compositions of matter, means, methods, or steps presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A method, comprising:
transmitting, by a transmitter of variable bit rate (VBR) data, data during each sub-slot of a plurality of sub-slots over a predetermined period of time, wherein the plurality comprises an allotment of sub-slots of a beacon period for the transmitter, wherein further the transmitting is to enable generation of an interference signature when the transmitter would otherwise not use all sub-slots of the plurality over the predetermined period;
sensing, by a receiver of an mmWave network, transmission of the data during each of the sub-slots of the plurality over the predetermined period of time; and
generating the interference signature, wherein the interference signature is to enable a coordinator of the mmWave network to schedule transmissions of the receiver and mitigate interference from the transmitter.

2. The method of claim 1, further comprising: disabling, in the transmitter, the transmission of data during each of the sub-slots of the plurality over the predetermined period of time to prevent the interference mitigation.

3. The method of claim 1, further comprising: conserving, by at least one device in the mmWave network, power during the predetermined period based on the scheduled transmissions.

4. The method of claim 1, further comprising: gathering, by the coordinator, data of multiple interference signatures of multiple receivers of the mmWave network to schedule transmissions of the multiple receivers.

5. The method of claim 4, wherein the generating the interference signature comprises the coordinator generating the interference signature based on data transmitted from the receiver.

6. The method of claim 1, wherein the generating the interference signature comprises transmitting the interference signature from the receiver to the coordinator.

7. The method of claim 1, wherein the generating the interference signature is to enable the coordinator to schedule time division multiple access (TDMA) transmissions of super-frames of the mmWave network.

8. An apparatus, comprising:
a transmitter to transmit variable bit rate (VBR) data during an allotment of sub-slots; and
a sub-slot manager to cause the transmitter to transmit data during each of the sub-slots of the allotment over a predetermined period of time to enable creation of an interference signature, wherein transmission demand of the transmitter is less than the capacity of all sub-slots of the allotment during each beacon period of the predetermined period, wherein further the interference signature is for a receiver of a millimeter wave (mmWave) network.

9. The apparatus of claim 8, wherein the sub-slot manager comprises a state machine coupled to a clock and to dynamic random access memory (DRAM).

10. The apparatus of claim 8, wherein the sub-slot manager comprises a processor coupled to dynamic random access memory (DRAM).

11. The apparatus of claim 10, wherein the sub-slot manager is configured to create the interference signature and transmit the interference to a coordinator to enable the coordinator to schedule transmissions of receivers of the mmWave network.

12. The apparatus of claim 10, wherein the sub-slot manager is configured to transmit data to a coordinator to enable the coordinator to create the interference signature and schedule transmissions of receivers of the mmWave network.

13. The apparatus of claim 10, wherein the sub-slot manager is configured to transmit data of an interference report to a coordinator, wherein further the interference report comprises interference data based on antenna directivity of the apparatus.

14. The apparatus of claim 10, wherein the sub-slot manager is configured to disable the transmission of data during each of the sub-slots of the allotment if the environment of the mmWave network is a low data density environment, wherein further the sub-slot manager is configured to dynamically change the assignment of sub-slots of the allotment to accommodate changes of application demands of the apparatus.

15. The apparatus of claim 10, wherein the sub-slot manager is configured to transmit data during each of the sub-slots in a sequentially manner during sequential beacon periods.

16. The apparatus of claim 15, wherein the sub-slot manager is configured to transmit null data during at least one of the sub-slots.

17. A system, comprising:
a wireless transmitting device coupled to an antenna, the antenna configured to transmit variable bit rate (VBR) data and cause interference to a receiver in a millimeter wave (mmWave) network;
dynamic random access memory (DRAM) to store coded instructions; and
a processor coupled to the DRAM, the processor to execute the coded instructions and cause the wireless transmitting device to transmit data during each sub-slot of an allotment of sub-slots over a predetermined period of time, wherein the transmission of data during each sub-slot of the allotment is to enable creation of an interference signature via actions of the receiver despite demand of the wireless transmitting device being less than the throughput of the allotment in each beacon period of the predetermined period.

18. The system of claim 17, wherein the wireless transmitting device comprises a media access control (MAC) unit to process MAC protocol data units (MPDUs) from data provided by the processor, a basedband processor to process baseband signals for the MPDUs, and a radio frequency (RF) unit to generate radio signals from the baseband signals and transmit the radio signals via the antenna.

19. The system of claim 18, wherein the coded instructions enable the processor to determine average sub-slot usage of the allotment, determine an average quantity of null data to among each of the sub-slots.

20. The system of claim 19, wherein the coded instructions enable the processor to switch off one or more elements of the wireless transmitting device to conserve power during the predetermined period.
